(19) United States
(12) Patent Application Publication
(10) Pub. No.: US 2014/0358255 A1
(43) Pub. Date: Dec. 4, 2014

(54) INFORMATION OUTPUT DEVICE, INFORMATION OUTPUT METHOD AND INFORMATION OUTPUT PROGRAM

(71) Applicant: KABUSHIKI KAISHA TOSHIBA, Tokyo (JP)

(72) Inventors: Yoshinobu Fujiwara, Ome-shi (JP); Yasuhiro Morioka, Kawasaki-shi (JP); Atsushi Nakajima, Higashimurayama-shi (JP)

(73) Assignee: KABUSHIKI KAISHA TOSHIBA, Tokyo (JP)

(21) Appl. No.: 14/095,813

(22) Filed: Dec. 3, 2013

(30) Foreign Application Priority Data
May 31, 2013 (JP) 2013-115311

(51) Int. Cl. G05B 15/02

(52) U.S. Cl. CPC G05B 15/02
USPC 700/83

(57) ABSTRACT

According to at least one embodiment, an information output device, including, a communication module configured to receive first operation schedule information of an external device, a reproduction module configured to reproduce content, and an outputting module configured to output the first operation schedule information based on a reproduction progress state of the content.

### CROSS-REFERENCE TO RELATED APPLICATIONS

This application is based upon and claims the benefit of priority from Japanese Patent Application No. 2013-115311, filed May 31, 2013, the entire contents of which are incorporated herein by reference.

### FIELD

Embodiments described herein relate generally to an information output device, an information output method and an information output program.

### BACKGROUND

As a mechanism for connecting various home appliances such as a household electrical appliance like a refrigerator and a washing machine and an AV household electrical appliance like a television and a recorder to a network, and controlling them with a controller to optimize home energy consumption, a Home Energy Management System (HEMS) has attracted attention.

As a national HEMS interface standard, ECHONET Lite has been recommended.

Also, in recent years, a television comprising a storage function (so-called recording capability) of storing (recording) broadcast content, etc., has become prevalent. With a larger capacity and a lower price of a hard disk, etc., in which content is stored, many users are storing and saving a large amount of content.

As described above, a large amount of content tends to be saved, but daily viewing time is limited. Thus, a user may view content simultaneously with other work (for example, doing the laundry with a washing machine). In this case, the user cannot sufficiently enjoy reproduced content caring about the state of other appliances. However, an excessive notification from the other appliances is also annoying.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an information display system, according to an embodiment;

FIG. 2 is an exemplary diagram showing an example of a display device constituting the information display system, according to an embodiment;

FIG. 3 is an exemplary diagram showing an example of a sequence which displays household electrical appliance information in the display device, according to an embodiment;

FIG. 4 is an exemplary diagram showing an example of displaying the household electrical appliance information in the display device, according to an embodiment; and

FIG. 5 is an exemplary diagram showing an example of a household electrical appliance information by the display device, according to an embodiment.

### DETAILED DESCRIPTION

Various embodiments will be described hereinafter with reference to the accompanying drawings.

In general, according to one embodiment, an information output device, comprising: a communication module configured to receive first operation schedule information of an external device; a reproduction module configured to reproduce content; and an outputting module configured to output the first operation schedule information based on a reproduction progress state of the content.

Embodiments will now be described hereinafter in detail with reference to the accompanying drawings.

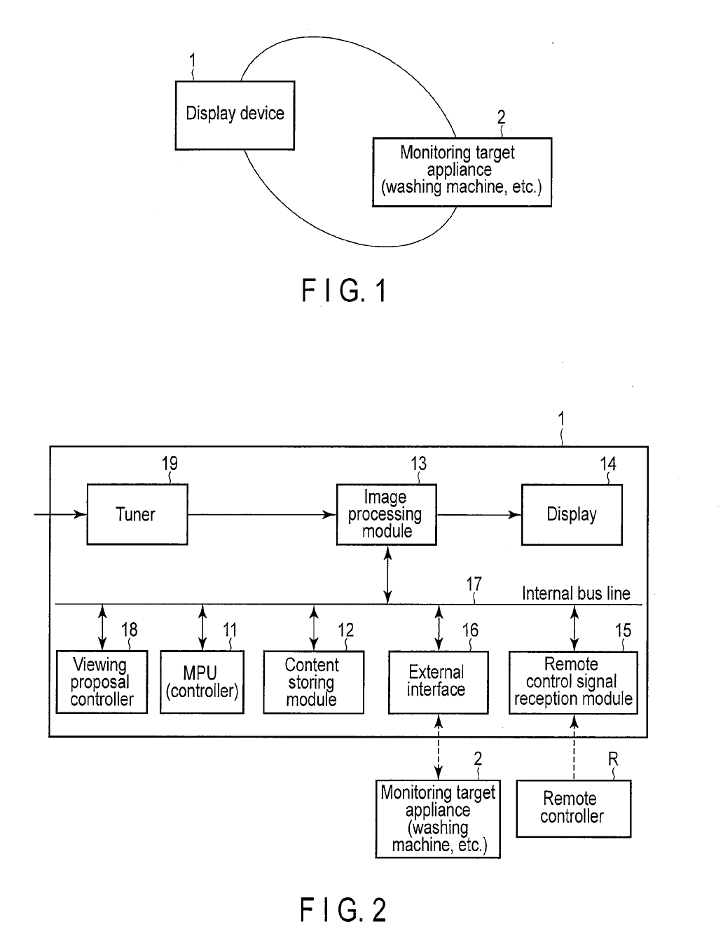

FIG. 1 shows a configuration example of an information display system according to the embodiment.

As shown in FIG. 1, the information display system comprises a display device 1 and a monitoring target appliance (for example, a household electrical appliance) 2. For example, the display device 1 is a device (digital television) capable of receiving, reproducing and storing a television broadcast, comprises a network interface, operates as a Controller of an ECHONET Lite standard, and comprises a display unit which functions as a household electrical appliance information display device configured to display household electrical appliance information.

For example, the monitoring target appliance 2 is a household electrical appliance (washing machine) which carries out washing and drying, comprises a network interface, and operates as a device conforming to the ECHONET Lite standard. A network is a wired network such as a LAN, or a wireless network such as Wi-Fi and Bluetooth (registered trademark).

FIG. 2 is a block diagram showing a configuration example of a display device constituting the information display system according to the embodiment.

As shown in FIG. 2, the display device 1 comprises an MPU (a controller) 11, a content storing module 12, an image processing module 13, a display 14, a remote control signal reception module 15, an external interface 16, an internal bus line 17, a viewing proposal controller 18, and a tuner 19.

The tuner 19 selects a signal of a designated channel from received broadcast signals and outputs the signal (content) of the designated channel. The image processing module 13 demodulates and reproduces the content based on the signal from the tuner 19. The display 14 displays the reproduced content. The content storing module 12 stores (records) the content based on the signal from the tuner 19.

Also, the image processing module 13 forms display image data from display data obtained through the internal bus line 17, and sends (outputs) it to the display 14. For example, the image processing module 13 can also synthesize a picture of the content and the display image data, and send (output) the synthesized picture to the display 14. In addition, the image processing module 13 can pause reproduction of the content and send (output) the display image data while reproduction of the content is paused. The display 14 is a CRT, an LCD or the like and displays the display image data received from the image processing unit.

The remote control signal reception module 15 receives a remote control signal from a remote controller R and transfers the remote control signal to the controller 11 through the internal bus line 17. The controller 11 is connected to the internal bus line 17, receives the remote control signal through the internal bus line 17, interprets the remote control signal, and controls every unit comprehensively based on the remote control signal.

The external interface 16 sends and receives data to and from the monitoring target appliance 2 via an interface such as LAN. The internal bus line 17 is an internal bus is connected every unit within the display device 1, and the internal bus line is used for the transfer of image data, etc., the transfer of information between every unit or the like.

The viewing proposal controller 18 carries out control and processing conforming to the ECHONET Lite standard, selects stored content from the content storing module 12, and sends display data for proposing viewing to a user to the image processing module 13.

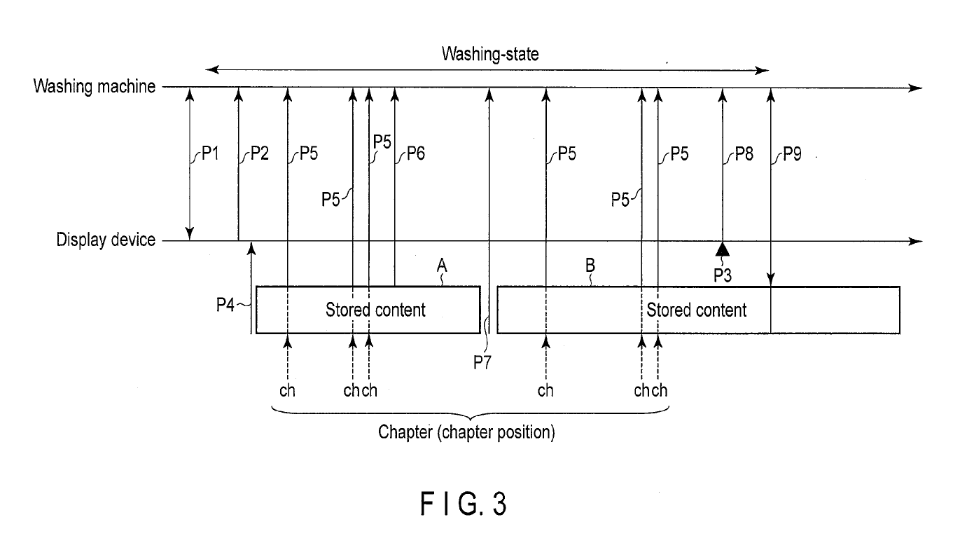

FIG. 3 is a sequence diagram showing an example of a sequence which displays the household electrical appliance information in the display device according to the embodiment.

For example, if the display device 1 (external interface 16, etc.) receives a power-on notification from a washing machine 2 (P1), it acquires (receives) a washing transition state (operating state information) and a remaining washing time (a remaining time until an estimated completion time of washing operation) from the washing machine by means of the ECHONET Lite standard (P2). If the washing transition state is not “completion and stop of washing” and the remaining washing time is not zero, the display device 1 (controller 11, etc.) sets the estimated completion time of washing operation based on the remaining washing time (P3). Then, the display device 1 (viewing proposal controller 18, etc.) proposes viewing one or more stored content (for example, stored content A and B) of a reproduction time (total reproduction time) which is greater than or equal to the remaining washing time (P4). For example, if the remaining washing time is 50 minutes, the reproduction time of stored content A is 30 minutes and the reproduction time of stored content B is 40 minutes, then the total reproduction time of stored content A and B is longer than the remaining washing time.

That is, the display device 1 receives operation schedule information including the remaining time until the estimated completion time of washing operation from the washing machine 2 and outputs a viewing guide of the one or more items of content based on the remaining washing time and the reproduction time of reproducible content. In the above description, a case of a guide to viewing one or more items of content which is greater than or equal to the remaining time is explained; however, the display device 1 may also accept a setting of a guide to viewing one or more items of content which is less than or equal to the remaining time.

The display device 1 (controller 11, the image processing module 13) reproduces the stored content monitoring a reproduction state (reproduction progress state) of the stored content, and outputs (displays) the operating state information and the operation schedule information from the washing machine 2 based on the reproduction state. The display device 1 may receive the operating state information and the operation schedule information based on the reproduction state, or may receive the operating state information and the operation schedule information periodically.

Also, the washing machine 2 updates the operating state information in accordance with a change in the operating state. Similarly, the washing machine 2 also updates the operation schedule information in accordance with the progress state of operation. For example, if the washing operation changes from a washing-state to the end of washing, the operating state information including washing-state information is updated to the operating state information including end-of-washing information. Also, as time passes (1 minute passes), the operation schedule information including the remaining washing time of 10 minutes is updated to the operation schedule information including the remaining washing time of 9 minutes. Also, there is a case where an actual elapsed time does not correspond to a reduced time of the remaining washing time. For example, as time passes (for example, 5 minutes pass), the operation schedule information including the remaining washing time of 10 minutes may be updated to the operation schedule information including the remaining washing time of 3 minutes as a result of recalculation.

For example, the display device 1 (the image processing module 13) starts reproduction of the stored content, acquires the washing transition state (operating state information) and the remaining washing time (operation schedule information) from the washing machine 2 based on the timing of passing through each chapter constituting the stored content (based on timing of starting reproduction of each chapter), and outputs (displays) at least one of the washing transition state, the remaining washing time and the estimated completion time of washing operation (P5). In addition, the display device 1 may acquire the washing transition state (operating state information) and the remaining washing time (operation schedule information) from the washing machine 2 periodically (beforehand), store the acquired washing transition state and remaining washing time, and output (display) at least one of the washing transition state, the remaining washing time and the estimated completion time of washing operation based on the stored washing transition state and remaining washing time with necessary timing (with timing of starting reproduction of each chapter). The washing transition state and remaining washing time, which are periodically acquired and stored, are updated based on the latest washing transition state and remaining washing time.

Also, if the user carries out the operations of fast-forward, fast-reverse, skip, pause, etc., via the remote controller R, the display device 1 executes fast-forward, fast-reverse, skip, pause, etc., in response to these operations, and then restarts reproduction. Based on the timing of restarting the reproduction, the display device 1 acquires the washing transition state (operating state information) and the remaining washing time (operation schedule information) from the washing machine, and outputs (displays) at least one of the washing transition state, the remaining washing time and the estimated completion time of washing operation (P6). In addition, the display device 1 may acquire the washing transition state (operating state information) and the remaining washing time (operation schedule information) from the washing machine 2 periodically (beforehand), store the acquired washing transition state and remaining washing time, and outputs (displays) at least one of the washing transition state, the remaining washing time and the estimated completion time of washing operation based on the stored washing transition state and remaining washing time with necessary timing (timing of restarting reproduction after fast-forward, fast-reverse, skip and pause).

Further, based on the timing with which a reproduction position of the stored content reaches the end of the stored content (based on timing of the end of reproduction), the display device 1 acquires the washing transition state and the remaining washing time from the washing machine 2 and outputs (displays) at least one of the washing transition state, the remaining washing time and the estimated completion time of washing operation (P7). In addition, the display device 1 may acquire the washing transition state (operating state information) and the remaining washing time (operation schedule information) from the washing machine 2 periodically (beforehand), store the acquired washing transition state and remaining washing time, and output (display) at least one of the washing transition state, the remaining washing time and the estimated completion time of washing operation based on the stored washing transition state and remaining washing time with necessary timing (timing of the end of reproduction).

Further another, based on the timing of reaching the estimated completion time of washing, the display device 1 acquires the washing transition state and the remaining washing time from the washing machine 2, and outputs (displays) at least one of the washing transition state, the remaining washing time and the estimated completion time of washing operation (P8). In addition, the display device 1 may acquire the washing transition state (operating state information) and the remaining washing time (operation schedule information) from the washing machine 2 periodically (beforehand), store the acquired washing transition state and remaining washing time, and output (display) at least one of the washing transition state, the remaining washing time and the estimated completion time of washing operation based on the stored washing transition state and remaining washing time with necessary timing (timing of reaching the estimated completion time of washing).

Still further, based on the timing with which the washing transition state becomes “completion and end of washing”, i.e., upon receiving the washing transition state including the completion and end of washing, the display device 1 pauses reproduction of the stored content and outputs (displays) the completion of washing while reproduction is paused (P9).

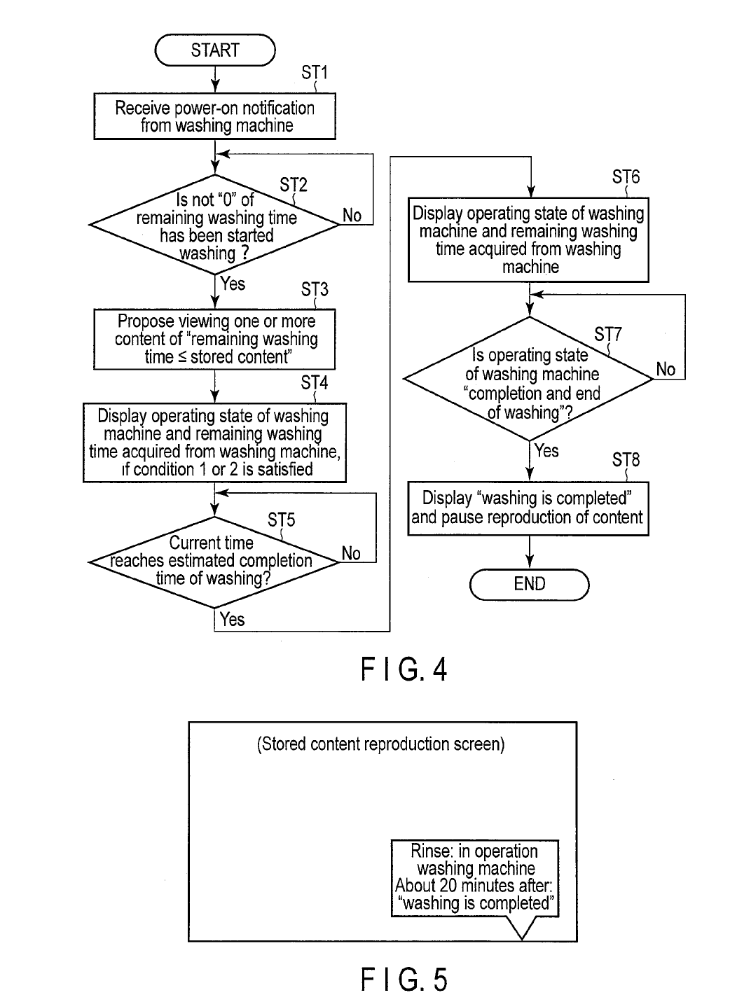

FIG. 4 is a flowchart showing a procedure of displaying the household electrical appliance information in the display device according to the embodiment.

The display device 1 (external interface 16, etc.) receives the power-on notification from the washing machine 2 (ST1). The display device 1 verifies whether washing has been started and the remaining washing time is not 0 (ST2). If washing has not been started or the remaining washing time is 0 (ST2, NO), the display device 1 continues monitoring the washing machine 2. If washing has been started and the remaining washing time is not 0 (ST2, YES), information for proposing viewing the one or more stored items of content which is greater than or equal to the remaining washing time is output (displayed) (ST3).

If the user selects an indication of not viewing the stored content based on a viewing proposal via the remote controller R, the display device 1 ends the viewing proposal. The display device 1 acquires the washing transition state and the remaining washing time from the washing machine 2, if the user selects an indication of viewing the stored content based on the viewing proposal via the remote controller R. Further, the display device 1 outputs (displays) the washing transition state and the remaining washing time after a certain period of time (ST4) based on the following condition 1 or 2;

Condition 1:

Carrying out the operations of fast-forward, fast-reverse, skip, pause, etc., and restarting reproduction,

Condition 2:

Reaching to the end of the stored content.

Then, the display device 1 verifies whether the current time reaches the estimated completion time of washing designated based on the remaining washing time (ST5). If it reaches (ST5, YES), the display device 1 acquires the washing transition state and the remaining washing time from the washing machine 2, and outputs (displays) the washing transition state and the remaining washing time (ST6). In the end, the display device 1 verifies whether the washing transition state is the completion and end of washing (ST7). If washing is completed, the display device 1 pauses reproduction of the stored content, and outputs (displays) a message saying “Washing is completed.”, etc. FIG. 5 shows a display example of the household electrical appliance information by the display device according to the embodiment.

According to the display device 1 of the embodiment, stored content that has been saved in large quantities can be efficiently consumed, and the state verification of household electrical appliances and the viewing of the stored content can be easily performed.

Hereinafter, the embodiment will be summarized.

If the user starts viewing the stored content simultaneously with washing by the washing machine 2, he or she cares about the washing state, the remaining washing time, etc. For example, the washing state and the remaining washing time are periodically notified from the washing machine 2 to the display device 1, and each time the display device 1 can display the washing state and the remaining washing time. However, if the frequency of display is high, the content may not be viewed in a relaxed manner.

The display device 1 of the embodiment can display the washing state and the remaining washing time of the washing machine 2 with appropriate timing.

For example, the display device 1 accepts the operations of fast-forward, fast-reverse, skip, pause, etc., and displays information on the washing state and the remaining washing time, etc., with the timing of restarting reproduction. Also, the display device 1 acquires the washing transition state and the remaining washing time from the washing machine 2 by means of ECHONET Lite with the timing of reaching the estimated completion time of washing designated based on the remaining washing time, and displays the washing transition state and the remaining washing time after a certain period of time. In addition, when passing through a chapter of the stored content, the display device 1 acquires the remaining washing time from the washing machine 2 by use of ECHONET Lite and updates the estimated completion time of washing. Also, the display device 1 proposes viewing the one or more stored items of content which is greater than or equal to the remaining washing time. If the washing transition state is “completion and end of washing”, the display device 1 pauses reproduction of the stored content and displays the completion of washing.

All the procedures of the above processes (information output) can be implemented as software. Thus, the above processes can be easily implemented simply by using a computer-readable storage medium storing a program for carrying out the procedures of the above processes, and installing and executing the program on a general computer.

For example, the display device 1 can download the program via the external interface 16, etc., store the downloaded program, and complete installation of the program. Hereby, the display device 1, which corresponds to the above computer, can easily implement the above processes (information output) based on the above installed program.

Also, the display device 1 can load the above program from the computer-readable storage medium, store the loaded program, and complete installation of the program.

In the embodiment, although a washing machine has been described as an example of the monitoring target appliance 2, the monitoring target appliance 2 is not limited to a washing machine. For example, the monitoring target appliance 2 may be a microwave oven or an electric cooker.

In addition, the procedures of the above processes may be implemented as hardware or may be implemented as software using a CPU or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information output device, comprising:
a receiver configured to receive first operation schedule information relating to an external device;
a processor configured to reproduce content and to output the first operation schedule information based on progress of the reproduction.

2. The information output device of claim 1, wherein the processor is configured to output the first operation schedule information based on an end time of the reproduction.

3. The information output device of claim 1, wherein the processor is configured to output the first operation schedule information based on a start time of the reproduction of at least one chapter of the content.

4. The information output device of claim 1, wherein the first operation schedule information is periodically updated information, the receiver is configured to receive second operation schedule information that is based on the periodically updated first operation schedule information, and the processor is configured to output the second operation schedule information.

5. The information output device of claim 1, wherein
the receiver is configured to receive operating state information relating to the external device, and
the processor is configured to output the operating state information based on the progress of the reproduction.

6. The information output device of claim 4, wherein the processor is configured to output a first estimated completion time of operation included in the first operation schedule information and/or a first remaining time until the first estimated completion time of operation.

7. The information output device of claim 6, wherein
the receiver is configured to receive updated second operation schedule information based on the first estimated completion time of operation, and
the processor is configured to output a second estimated completion time of operation included in the second operation schedule information and/or a second remaining time until the second estimated completion time of operation, such that the processor outputs the second estimate completion time of operation and/or the second remaining time instead of the first estimated completion time of operation and/or the first remaining time when the updated second operation schedule has been received.

8. The information output device of claim 1, wherein the processor is configured to output a viewing guide relating to one or more items of content based on a first remaining time until a first estimated completion time of operation included in the first operation schedule information and a reproduction time of each reproducible item of content.

9. The information output device of claim 8, wherein the processor is configured to output a viewing guide relating to an item of content of a reproduction time that is longer than or equal to the first remaining time.

10. The information output device of claim 8, wherein the processor is configured to output a viewing guide relating to a plurality of items of content of a total reproduction time that is longer than or equal to the first remaining time.

11. The information output device of claim 5, wherein
the processor is configured to pause reproduction of the content based on the operating state information, and to output the operating state information while reproduction of the content is paused.

12. The information output device of claim 11, wherein
the processor is configured to pause reproduction of the content based on operation completion information included in the operating state information, and
to output the operation completion information while reproduction of the content is paused.

13. The information output device of claim 12, wherein the receiver is configured to receive washing operation schedule information corresponding to the first operation schedule information and washing operation state information corresponding to the operating state information from a washing machine.

14. An information output method, comprising:
receiving first operation schedule information relating to an external device;
reproducing content; and
outputting the first operation schedule information based on progress of the reproduction.

15. A non-transitory computer readable medium having stored thereon a computer program that is executable by a computer, the computer program controlling the computer to execute functions of:
receiving first operation schedule information relating to an external device;
reproducing content; and
outputting the first operation schedule information based on progress of the reproduction.
